(19) United States
(12) Patent Application Publication
(10) Pub. No.: US 2012/0041889 A1
(43) Pub. Date: Feb. 16, 2012

(54) SYSTEMS AND METHODS FOR MATCHING AND LINKING EMPLOYEES WITH EMPLOYERS OF APPLICATION-BASED POSITIONS

(75) Inventors: Douglas Matthew Morrison, Lewis Center, OH (US); Amanda Kay Jones, Lewis Center, OH (US); Jacob Randall Osborn, Arlington, VA (US)

(73) Assignee: Match Link Partners LLC, Lewis Center, OH (US)

(21) Appl. No.: 13/284,243

(22) Filed: Oct. 28, 2011

(51) Int. Cl. G06Q 10/06

(52) U.S. Cl. 705/321

(57) ABSTRACT

The present invention relates generally to the provision of a Website portal for matching potential applicants to employers who are seeking to fill application-based positions (e.g., hourly-wage or restaurant or retail or similar positions). An applicant portal is provided to collect information from the applicants, to store the applicant information in a database, and to allow the applicants to perform other tasks. An employer portal is provided to collect employer information, to store the employer information in an employer database, to allow employers to search the applicants, to allow the employer to view uploaded videos provided by the applicants, and to allow employers to run background checks on the applicants. An applicant information database is stored in connection with the website, such that potential employees may be optimally matched and linked/connected to the most appropriate employer.

### FIELD OF THE INVENTION

The present invention relates generally to the provision of a Website portal for matching potential applicants to employers who are seeking to fill hourly-wage or restaurant or retail (or similar) positions. An employee information database is stored in connection with the website, such that potential employees may be optimally matched and linked to the most appropriate employer.

### BACKGROUND

As the gap between the upper and middle class continues to grow, more and more people seek hourly-rate positions in the retail and food service industry, and similar lower wage paying jobs. Whether for full or part time employment, many of these hourly-rate positions do not require a resume or curriculum vitae. However, most—if not all—of these hourly-rate positions require the applicant to fill out a paper or electronic application form. The application form commonly asks for personal information, as well as information specific to the hourly-rate position or category of business. Some of this information on the application form may be entirely dependent on the particular company looking to hire. For example, Company A might prefer that its applicants are able to speak Spanish, while Company B has no preferences regarding whether applicants are able to speak any foreign language and does not include this question on its application. Likewise, Company B might prefer to hire applicants that have previously served in the U.S. Armed Forces, while Company A has no preferences regarding whether applicants have previously served in the U.S. Armed Forces.

Partially due to the lack of employer consistency, but also due to many other factors, there are various problems associated with the current process for applying to hourly-wage positions.

Difficulty of Market Entrance. If a potential hourly-wage applicant does not have a personal connection at a particular company, it is often very difficult to get one's foot in the door. One reason for this is that many hourly-wage applicants do not have any prior work experience. Many counties and jurisdictions have a minimum legal working age, and some types of employment (e.g., dangerous or harmful to the health or that may affect the morals of minors) have an even higher legal working age. Thus, when a person is first able to take on an hourly-wage employment positions, it is often the case that he or she does not have any prior work experience. This can lead to a difficulty of market entrance. Another reason for the difficulty of market entrance is the volume of applications that employers receive each week to review. Many companies—especially in a market with a high unemployment rate—receive dozens if not hundreds of applications per week. This inevitably may cause the more-suitable candidate's application to become buried in the backlog.

Redundancy. When an hourly-wage applicant wishes to apply to multiple hourly-wage positions (e.g., food service and retail companies), much time is often required for the applicant to individually visit each company and fill out the specific paper form required by that company. Even if the company has a Website—which many companies don't—much time is spent visiting each company's individual Website. This time adds up, and can present a time-cost factor that ultimately discourages many applicants from applying for many suitable hourly-rate positions. In fact, the applicant might inadvertently not apply to employment that would be most suitable for the applicant. Additionally, the same information is often requested by different potential employers. For instance, if a candidate were to fill out a dozen applications, it is likely that his or her address and phone number would be written or entered a dozen times.

Lack of Consistency. As briefly mentioned above, different employers often have different application requirements. Sometimes these different requirements are based on something specific to the business of the potential employer, but often the employer does not even realize the importance or relevance of the applicant information it requests. For instance, it is possible that a fast food restaurant might maintain a high employee turn-over ratio because of the geographic distance from which its employees live, however, when making hiring decisions, the fast food manager might not pay particular attention to the relative distance of the applicants' place of residence.

Lack of Applicant Sophistication. Many applicants lack the resume-drafting skills necessary for employment in high-paying positions. And similarly, many applicants do not pay attention to the details required to fill out a paper application. Many applications contain incomplete or incorrect information, and as such, they become a waste of both the applicant's time and the application-reviewer's time. There are often problems associated with the process of vetting potential applicants and interviewing selected applications. An applicant might appear to be sophisticated due to the complete nature of his or her application, but then during the interview it is immediately realized that the applicant is not qualified for the position and was assisted in filling out the application. This is a waste of time to the employer and the applicant.

High Turnover Rate. Typical employee turn-over rates in the retail, fast food, and other lower hourly wage paying industries can exceed 150%. This means that if a small store employs only 15 people, approximately 2-3 people are hired each month. The amount of administrative time and costs spent on keeping up with the high turnover rates can be very costly to companies.

Lack of Ability to Quickly Sort or Filter Applications. The typical paper application collection system does not facilitate a way to quickly and easily sort through potential applications for specific requirements. For instance, if a sports bar needs to hire a server over the age of 21 in order to serve alcohol, it would be arduous and cumbersome to sift though hundreds of applications (or more) to filter the over-age applicants from the under-age applications. With paper applications, sorting and filtering by availability, geographic location, age, education or skill set is difficult, if not impossible. Individual company websites that provide for an electronic application may allay some of these concerns, however, restaurants and hourly-wage companies may or may not realize the important information to filter, and in any even other concerns are not addressed with this solution.

Limited Value of Application Information. Even if appropriate sorting if performed, many applications may be of limited value to the potential employer. This is often because the requested information has limited value; often data is of limited value in dealing with many hourly-wage employees, due to the nature of many hourly-wage positions. For instance, an interviewee for a fast-food position might gain much more information about an applicant's suitability for a position by conducting a 2 minute person-to-person interview, rather than any information requested by a paper application.

Cost of Outsourcing. Currently, there are web-based platforms for job placement. But all of these websites are costly and rarely are targeted to the hourly-wage applicant. For instance, the number one job placement website Monster.com charges from $210 to $395 to post a 60-day or 90-day advertisement, based on the location of the employer. This high cost is prohibitive for hourly-wage employers. Not to mention, most if not all of these Websites require resumes, which for the reasons explained above is impractical for the hourly-wage applicant.

Many other problems exist with current systems and methods, but this simply highlights a few of the problems that the present invention is designed to address in order to provide a more efficient, Web-based solution.

### SUMMARY OF THE INVENTION

Accordingly, techniques and supporting systems and methods as described herein address the above-described problems, as well as other issues facing job applicants and hourly-wage employers. In order for hourly-based employment applicants and employers to fully realize the benefits of systems and methods designed to provide a more efficient solution, it must become simpler for the applicants to provide relevant application information, as well as easier for the employers to customize searches to meet their needs. Also, it may become important to automatically provide relevant searches for the employers based on past data to appropriately match and link the optimal applicant.

Therefore, in one aspect of the present invention, a computer-implemented method is provided for providing an employee website. The method includes providing an applicant user interface to a job applicant, and receiving at a host server first data from the job applicant via the applicant user interface. The first data includes contact information of the job applicant, the available work hours of the job applicant, the residence address of the job applicant, and a link to a video of the job applicant. The method also includes storing an applicant profile for the job applicant on the host server, and the applicant profile includes at least the first data. The method further includes providing an employer user interface to an employer, and receiving at the host server second data from the employer via the employer user interface. In this way, the second data includes contact information for the employer and additional employer information. The method also includes storing an employer profile for the employer on the host server, and the employer profile includes at least the second data. The method also includes receiving at the host server third data from the employer via the employer user interface (where the third data includes search criteria related to data received from the job applicant), providing search results to the employer via the employer user interface (where the search results are based on the search criteria), and providing an option for the employer to sort the search results via the employer user interface). Finally, the method includes providing an option for the employer to view the video of the job applicant via the employer user interface.

In certain embodiments, the method also includes providing an option for the employer to request to be connected with the applicant and sending a request to the applicant. The request includes employer information and requesting the applicant's permission to share the applicant's contact information with the employer. The method also includes receiving a response from the applicant, where the response indicates whether the applicant authorizes the applicant's contact information to be shared with the employer. The method also includes sending a message to the employer, and the message includes the applicant's contact information if the applicant authorized the contact information to be shared with the employer, and on the other hand the message does not include the contact information if the applicant did not authorize the contact information to be shared with the employer.

In certain embodiments, the method also includes providing an electronic map to the applicant via the applicant user interface, and the electronic map shows an indication for each employer based on the employer address and the electronic map is centered on the residence address of the job applicant.

In other embodiments, the method also includes providing an option for the applicant to automatically generate a resume via the applicant user interface, and the resume is generated based on the data stored as the applicant profile.

In other embodiments, the method also includes providing an option for the employer to request a background check of the applicant.

In another exemplary embodiment, a system is described for providing an employment website. The system includes an applicant user interface module for providing an applicant user interface to a job applicant, and a first data receiving module for receiving at a host server first data from the job applicant via the applicant user interface. The first data includes contact information of the job applicant, the available work hours of the job applicant, the residence address of the job applicant, and a link to a video of the job applicant. The system also includes an applicant profile module for storing an applicant profile for the job applicant on the host server, and the applicant profile includes at least the first data.

The system also includes an employer user interface providing module for providing an employer user interface to an employer, and a second data receiving module for receiving at the host server second data from the employer via the employer user interface. The second data includes contact information for the employer and additional employer information. The system also includes an employer profile module for storing an employer profile for the employer on the host server, and the employer profile includes at least the second data. The system includes a third data receiving module for receiving at the host server third data from the employer via the employer user interface, and the third data includes search criteria related to data received from the job applicant. Finally, the system includes a search results module for providing search results to the employer via the employer user interface (where the search results are based on the search criteria), a sorting option module for providing an option for the employer to sort the search results via the employer user interface, and a video module for providing an option for the employer to view the video of the job applicant via the employer user interface.

In certain embodiments, the system also includes a connection module for providing an option for the employer to request to be connected with the applicant and a request module for sending a request to the applicant. The request includes employer information and requesting the applicant's permission to share the applicant's contact information with the employer. The system also includes a response module for receiving a response from the applicant, where the response indicates whether the applicant authorizes the applicant's contact information to be shared with the employer. The system also includes a message sending module for sending a message to the employer, and the message includes the applicant's contact information if the applicant authorized the contact information to be shared with the employer, and on the other hand the message does not include the contact information if the applicant did not authorize the contact information to be shared with the employer.

In certain embodiments, the system also includes an electronic map module for providing an electronic map to the applicant via the applicant user interface, and the electronic map shows an indication for each employer based on the employer address and the electronic map is centered on the residence address of the job applicant.

In other embodiments, the system also includes a resume generation module for providing an option for the applicant to automatically generate a resume via the applicant user interface, and the resume is generated based on the data stored as the applicant profile.

In other embodiments, the system also includes a background check module for providing an option for the employer to request a background check of the applicant.

In another embodiment, a computer-implemented method is provided for matching an applicant to an employer based on the applicant's application. The method includes providing an employer user interface to an employer and receiving at a host server first data from the employer, where the first data includes location and contact information regarding one or more employment locations. The method also includes receiving at the host server second data from the employer, and the second data includes a designation of one location from the one or more employment locations. The second data also includes employer requirements, where the employer requirements includes work availability required by the employer and at least one of the following pieces of information: the minimum age required by the employer, the maximum distance from the designated location's address to an applicant's home address required by the employer, how soon the applicant must be able to begin work, the type of employment required by the employer, the minimum level of education required by the employer, whether a valid drivers license is required by the employer, and the previous industry experience required by the employer.

The method also includes providing the employer with a table of one or more applicants, where the table of one or more applicants conforms to the requirements included in the second data, and where each row in the table of one or more applicants includes at least three pieces of information for each of the one or more applicants. The options for the three pieces of information come from the group: distance from applicant home address to the location address, percentage completeness of applicant application, how soon the applicant is able to begin work, whether the applicant had provided a video, and whether the applicant had authorized a background check.

The method also includes receiving at the host server a request from the employer to view an applicant video, and the applicant video has been previously provided by the applicant. The method also includes providing the employer with an interface for viewing the applicant video, as well as receiving at the host server a request from the employer to connect with the applicant. The method also includes sending a message to the applicant from the host server, where the message includes employer information or location information, and the message further requests the applicant's permission to share the applicant's contact information with the employer. The method includes receiving at the host server a response from the applicant, where the response indicates whether the applicant authorizes the applicant's contact information to be shared with the employer. Finally, the method includes providing the applicant's contact information to the employer if the applicant authorized the applicant's contact information to be shared with the employer.

In another aspect of the present invention, the method also includes providing the employer with the number of applicants that conform to the requirements in the second data before providing the employer with the table of one or more applicants, as well as receiving at the host server a request from the employer to be provided with the table of one or more applicants.

In yet another embodiment, the table of one or more applicants further includes an icon or link in each row that enables the employer to request to connect with each of the one or more applicants, and the table of one or more applicants also includes an icon or link in each row that enables the employer to save the applicant to a saved applicants list.

In a further exemplary embodiment, the table of one or more applicants is color coded by applicant based on at least whether the one or more applicants are saved to the saved applicants list, whether the one or more applicants have an outstanding connection request, and whether the one or more applicants have already responded to a connection request.

In another embodiment, the response from the applicant is via email or via text message or via an internal system message.

In another embodiment, a system is provided for matching an applicant to an employer based on the applicant's application. The system includes an employer user interface module for providing an employer user interface to an employer, and a first data receiving module for receiving at a host server first data from the employer, where the first data includes location and contact information regarding one or more employment locations. The system also includes a second data receiving module for receiving at the host server second data from the employer, and the second data includes a designation of one location from the one or more employment locations. The second data also includes employer requirements, where the employer requirements includes work availability required by the employer and at least one of the following pieces of information: the minimum age required by the employer, the maximum distance from the designated location's address to an applicant's home address required by the employer, how soon the applicant must be able to begin work, the type of employment required by the employer, the minimum level of education required by the employer, whether a valid drivers license is required by the employer, and the previous industry experience required by the employer.

The system also includes a table providing module for providing the employer with a table of one or more applicants, where the table of one or more applicants conforms to the requirements included in the second data, and where each row in the table of one or more applicants includes at least three pieces of information for each of the one or more applicants. The options for the three pieces of information come from the group: distance from applicant home address to the location address, percentage completeness of applicant application, how soon the applicant is able to begin work, whether the applicant had provided a video, and whether the applicant had authorized a background check.

The system also includes a video request receiving module for receiving at the host server a request from the employer to view an applicant video, and the applicant video has been previously provided by the applicant. The system also includes a video module for providing the employer with an interface for viewing the applicant video, as well as a connection request module for receiving at the host server a request from the employer to connect with the applicant. The system also includes a message sending module for sending a message to the applicant from the host server, where the message includes employer information or location information, and the message further requests the applicant's permission to share the applicant's contact information with the employer. The system includes a response receiving module for receiving at the host server a response from the applicant, where the response indicates whether the applicant authorizes the applicant's contact information to be shared with the employer. Finally, the system includes a contact providing module for providing the applicant's contact information to the employer if the applicant authorized the applicant's contact information to be shared with the employer.

In another aspect of the present invention, the system also includes a number providing module for providing the employer with the number of applicants that conform to the requirements in the second data before providing the employer with the table of one or more applicants, as well as a table request receiving module for receiving at the host server a request from the employer to be provided with the table of one or more applicants.

In yet another embodiment, the table of one or more applicants further includes an icon or link in each row that enables the employer to request to connect with each of the one or more applicants, and the table of one or more applicants also includes an icon or link in each row that enables the employer to save the applicant to a saved applicants list.

In a further exemplary embodiment, the table of one or more applicants is color coded by applicant based on at least whether the one or more applicants are saved to the saved applicants list, whether the one or more applicants have an outstanding connection request, and whether the one or more applicants have already responded to a connection request.

In another embodiment, the response from the applicant is via email or via text message or via an internal system message.

It is to be understood that both the foregoing general description of the invention and the following detailed descriptions are exemplary, but are not restrictive, of the invention.

### BRIEF DESCRIPTION OF THE DRAWINGS

The foregoing and other objects, features, and advantages of the present invention, as well as the invention itself, will be more fully understood from the following description of various embodiments, when read together with the accompanying drawings, in which:

FIG. 1 illustrates a generic computer system that may be used to access the inventive systems and methods for matching and linking applicants to potential employers;

FIG. 2 illustrates a diagram of a Web server for providing the applicant and employer portals;

FIG. 3 illustrates a high-level process flow diagram of an embodiment related to the applicant portal; and

FIG. 4 illustrates a high-level process flow diagram of an embodiment related to the employer portal.

### DETAILED DESCRIPTION

The detailed description set forth below, in connection with the associated drawings, is intended to provide a description of the presently-preferred embodiments of the invention, and is in no way intended to limit the forms in which the present invention may be construed or used. Accordingly, it is well-understood by those with ordinary skill in the art that the same or equivalent functions may be accomplished by different embodiments that are also intended to be encompassed within the spirit and scope of the present invention. Moreover, with respect to particular method steps, it is readily understood by those with skill in the art that the steps may be performed in any order, and are not limited to any particular order unless expressly stated or otherwise inherent within the steps.

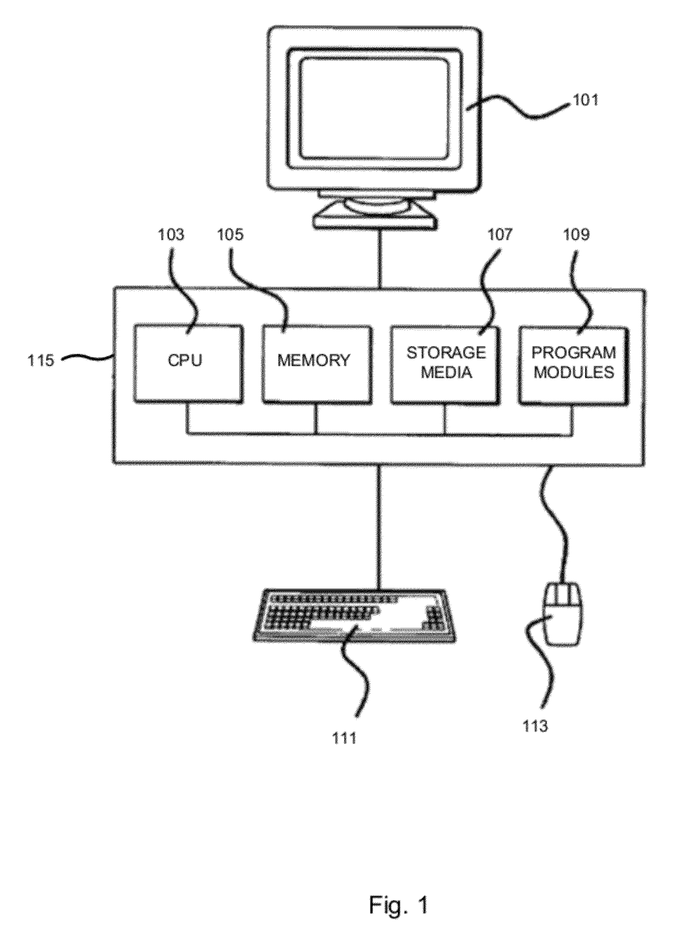

FIG. 1 shows a generic computer system that may be used to access the system and method for matching and linking applicants to potential employers. The exemplary preferred embodiment includes two Web interfaces for accessing the system and method, referred to as the “applicant portal” and the “employee portal” (collectively, the “portal”). These two interfaces might actually be the same interface, different interfaces located on the same Website, or different interfaces located on the same Webpage, as explained in more detail below. In any event, FIG. 1 shows a generic computer system for accessing the portal, and is not intended in any way to limit the claimed invention. The generic computer system shown in FIG. 1 includes a general purpose computing device 115 including a processing unit 103, a system memory 105, and a system bus that couples various system components including the system memory 105 to the processing unit 103.

Computers 115 typically include a variety of computer readable media that can form part of the system memory 105 and be read by the processing unit 103. By way of example and not limitation, computer readable media may include computer storage media 107 and communication media. The system memory may include computer storage media 107 in the form of volatile and/or nonvolative memory such as read only memory (ROM) and random access memory (RAM). A basic input/output system containing the basic routines that help to transfer data and information between elements, such as during start-up, is typically stored in ROM. RAM typically contains data and/or program modules 109 that are easily accessible to and/or presently being operated on by the processing unit 103.

The data or program modules 109 may include an operating system, application programs, other program modules, and program data. As used herein, the term “data” refers broadly to any digital information whether in storage or in transit. Generally, program modules 109 include routines, programs, objects, components, data structures, etc. that perform particular tasks. The operating system may be or include a variety of operating systems such as the Microsoft Windows® operating system, the Unix operating system, the Linux operating system, or any other operating system or platform.

The memory 105 includes at least one set of instructions that is either permanently or temporarily stored. The processor 103 executes the instructions that are stored in order to process data. The set of instructions may include various instructions that perform a particular task or tasks. Such a set of instructions for performing a particular task may be characterized as a program, software program, routine, software, engine, module, component, mechanism, or tool.

The matching and linking system may include a plurality of software processing modules stored in a memory 105 and executed on a processor 103. The program modules 109 may be in the form of any suitable programming language, which is converted to machine language or object code to allow the processor 103 or processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language or languages used may include assembly language, Actionscript, Basic, C, C++, C#, COBOL, Coldfusion, CSHTML, CSS, dBase, Delphi, Forth, FORTRAN, HTML, Java, JavaScript, Lisp, Modula-2, Objective C, Pascal, Perl, PHP, Prolog, Python, Ruby, Scheme, Shell, SQL, and/or Visual Basic for example. A person with ordinary skill in the art would readily understand that it is not necessary that a single type of instruction or programming language be utilized in conjunction with the operation of the systems and methods of the invention. Rather, any number of different programming languages may be utilized as necessary or desirable, and the above listed languages are illustrative only.

Also, the instructions and/or data used in the practice of the invention may or may not utilize any compression or encryption techniques or algorithms, as may be desired. An encryption module might be used to encrypt data. Further, files or other data may be decrypted using a suitable decryption module.

The computing environment may also include other removable and/or nonremovable volatile or nonvolatile computer storage media 107. For example, a hard disk drive may read or write to nonremovable, nonvolatile magnetic media. A magnetic disk drive may read from or write to a removable, nonvolatile magnetic disk, and an optical disk drive may read from or write to a removable, nonvolatile optical disk such as a CD ROM or other optical media. Other removable/nonremovable, volatile/nonvolatile computer storage media 107 that can be used in the exemplary operating environment include, but are not limited to, magnetic tape cassettes, flash memory cards, digital versatile disks, digital video tape, solid state RAM, solid state ROM, and the like. The storage media 107 are typically connected to the system bus through a removable or non-removable memory interface.

The processing unit 103 that executes commands and instructions may be a general purpose computer 115, but may utilize any of a wide variety of other technologies including a special purpose computer, a handheld device (e.g., iPod, iPad, PDA, mobile device) a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID integrated circuits, smart chip, or any other device or arrangement of computing devices that is capable of implementing the steps of the processes of the invention.

It should be appreciated that the processors 103 and/or memories 105 of the computer 115 need not be physically in the same location. Each of the processors 103 and each of the memories 105 used by the computer 115 may be in geographically distinct locations and be connected so as to communicate with each other in any suitable manner. Additionally, it is appreciated that each of the processor 103 and/or memory 105 may be composed of different physical pieces of equipment, and will likely include other pieces of equipment not specifically mentioned herein.

A user may enter commands and information into the computer through a user interface. The user interface may include input devices such as a keyboard 111 and a mouse 113, trackball or touch pad. Other input devices may include a microphone, joystick, game pad, satellite dish, scanner, voice recognition device, touch screen, toggle switch, pushbutton, or the like. These and other input devices may be connected to the processing unit 103 through a user input interface that is coupled to the system bus, but may be connected by other interface and bus structures, such as a parallel port, game port or universal serial bus (USB).

One or more monitors 101 or display devices may also be connected to the system bus via an interface. In addition to display devices, computers may also include other peripheral output devices, which may be connected through an output peripheral interface. The computers implementing the invention may operate in a networked environment using logical connections to one or more remote computers, the remote computers typically including many or all of the elements described above.

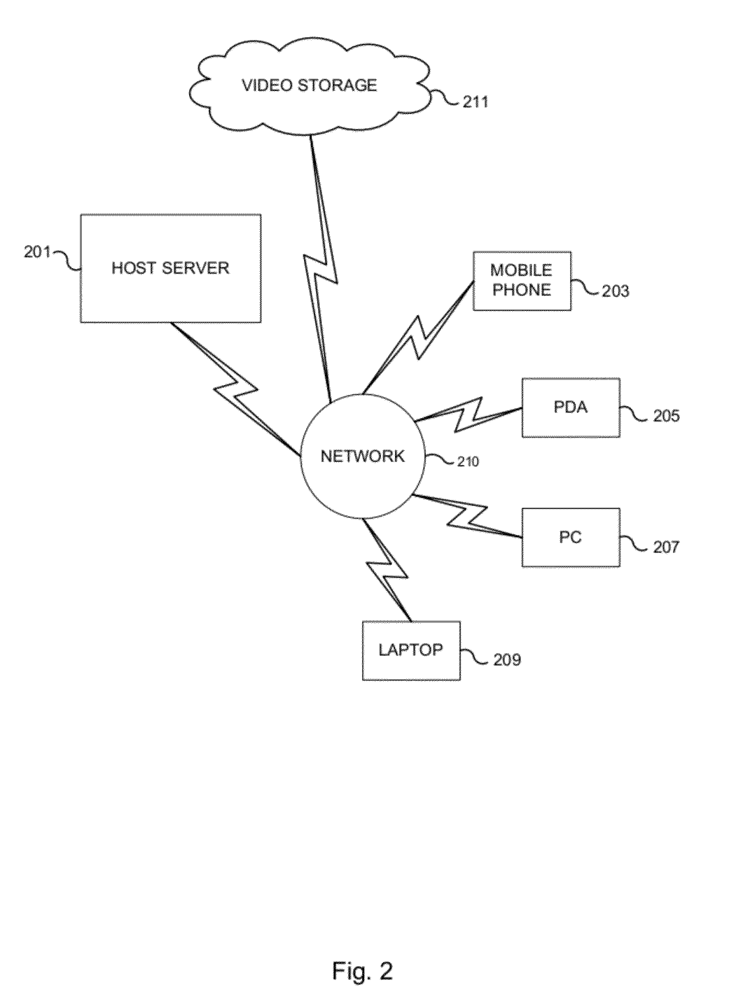

As shown in FIG. 2, a preferred embodiment for the systems and methods offers a client/server model of communication. In the client/server model of communication, one program (namely, the client) communicates with another program (namely, the server 201) for the purpose of exchanging data/information. Typically, the Website provider maintains the server 201 (i.e., hosts the Website), and the end user operates the client on his or her personal computer 207 or other computing device 203, 205, 209 in order to access the Website. Those skilled in the art will appreciate that the invention may be practiced with various system configurations, including hand-held wireless devices such as mobile phones 203 or PDAs 205, multiprocessor systems, personal computers 207, microprocessor-based or programmable consumer electronics, minicomputers, mainframe computers, laptops 209, and the like. The client usually consists of a Web browser, which is an interactive program that requests, retrieves, and displays pages from the World Wide Web. Popular Web browsers include Internet Explorer, Firefox, Chrome, Safari, Opera, and Android.

In FIG. 2, the host server 201 is a Web server for providing the applicant portal and the employer portal. In other words, the host server 201 provides the Web site, database, application code, etc. for matching and linking potential employees to hourly-wage employers. In addition, the host server 201 may perform other inventive functions as described more fully below. Although a single host server 201 is show, a distributed computer environment may be utilized, including multiple host servers or a cloud computing environment. In any event, the specific topology is not important to the inventive methods and systems, and as such is not meant to be limiting in any way.

A person with ordinary skill in the art would readily understand how typically client/server communications are performed. In the typical client/server system, the client (e.g., browser on PC 207) communicates a request to access a particular Website to the Website host server 201. The server 201 communicates a response back to the client, usually providing the Website information and content to the end user. The server 201 can also receive data and other requests from the client, and the server 201 may additionally perform computing operations in order to provide the client with particular data requested by the client. The communication between the client and the server 201 typically follows a standard—the Hypertext Transfer Protocol (HTTP). HTTP is the networking protocol that is the foundation of data communication over the World Wide Web.

Various networks 210 may be used in accordance with embodiments of the invention, including a wired or wireless local area network (LAN) and a wide area network (WAN), wireless personal area network (PAN) and other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. The communication may take place via any media such as standard telephone lines, LAN or WAN links (e.g., T1, T3, 56 kb, X.25), broadband connections (ISDN, Frame Relay, ATM), wireless links (802.11, Bluetooth, etc.), and so on. Preferably, the network can carry TCP/IP protocol communications, and HTTP/HTTPS requests made by the Web browser and the connection between the client software and the server 201 can be communicated over such TCP/IP networks. The type of network is not a limitation, however, and any suitable network may be used. Non-limiting examples of networks that can serve as or be part of the communications network include a wireless or wired Ethernet-based intranet, a local or wide-area network (LAN or WAN), and/or the global communications network known as the Internet, which may accommodate many different communications media and protocols.

Other suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths. For some aspects of the invention, such as for the transfer of payments, the communications infrastructure may include networked systems such as the Electronic Funds Transfer (EFT) network, and other communication channels known in the industry.

The invention may also be practiced in distributed computing environments where tasks are performed by remote processing devices that are linked through a communications network 210. In a distributed computing environment, program modules may be located in both local and remote computer storage media including memory storage devices.

In some cases, relational (or other structured) databases may provide such functionality, for example as a database management system which stores data related to the services and consumers utilizing the service. Examples of databases include the MySQL Database Server or ORACLE Database Server offered by ORACLE Corp. of Redwood Shores, Calif., the PostgreSQL Database Server by the PostgreSQL Global Development Group of Berkeley, Calif., or the DB2 Database Server offered by IBM.

Although many other internal components of the network 210 and computing devices are not shown, those of ordinary skill in the art will appreciate that such components and the interconnections are well known. Accordingly, additional details concerning the construction of the networks and computing devices need not be disclosed in connection with the present invention.

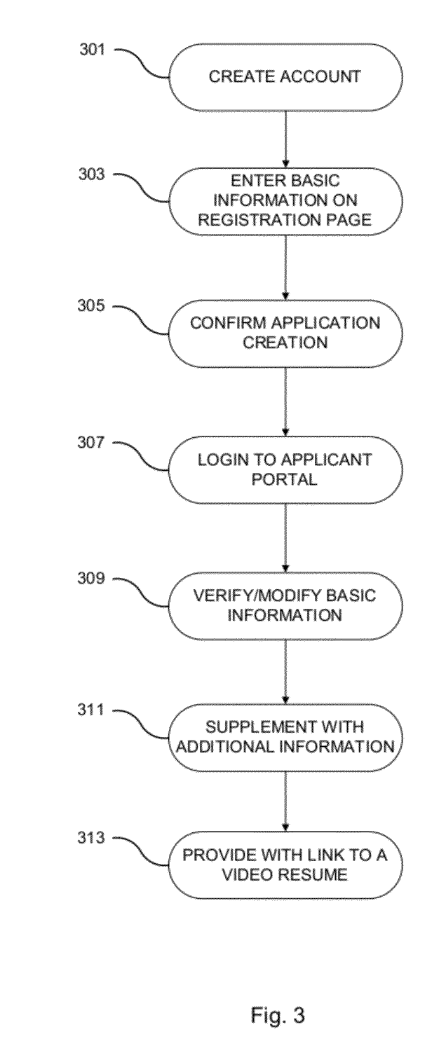

FIG. 3 shows a preferred embodiment process flow diagram related to the applicant portal. The process for the potential applicant begins with an applicant Website home page, where the applicant can either login 307 to the applicant portal or else create an account 301. It is to be understood that other features may also be possible from the applicant home page, such as marketing descriptions, maps showing the potential employers in applicant's area, and the like. If the applicant has not previously created an account, it will be required that he or she create an account 301 so that access to the portal may be granted. In a preferred embodiment, the applicant clicks a link entitled “Create an Account” from the homepage, and the applicant is then redirected to a Registration Page that asks for basic applicant information. Redirection to a new Webpage is not always necessary, as a popup page or other way to offer a Registration Page is also possible.

The Registration Page instructs the applicant that in order to register an account with the Website, basic user information in the form of data fields is required to be entered 303. Some of the data fields may be required by the Website, as is often indicated on the Website with a star (*required), however, other data fields may not be required but are purely optional. In a preferred embodiment, the data that is requested on the Registration Page is the applicant's first name, middle initial, last name, date of birth, cell phone number, home phone number, address, apartment number, city, state, zip, length at current address, email address, and desired account password. Other data fields, such as requested username, and a second confirmation password, may also be included in the Registration Page, and some of the data fields listed above may be absent. At this point, for instance, the applicant may be required to agree to the Website' s terms of use.

By entering all of the required information and optionally entering the optional information, the applicant submits the form to the host server 201 which then stores this information in an applicant database. The password may be required to be entered twice, and of course certain html validation operations are performed on the data to ensure the accuracy and/or legitimacy of the data entries. Any data entry errors may be noted to the applicant and the opportunity presented to the applicant correct the errors. At this point, in one embodiment, the Web server 201 causes an email to be transmitted to the applicant that thanks the applicant for registering and instructs the applicant to click on a link to verify or confirm the email address 305. This is a common way to verify the authenticity of the applicant's registration and to ensure that the proper email address was provided. However, it is also possible that the step of confirming the email address 305 is not required in order to keep the applicant engaged with the Website without having to break up the process. In a preferred embodiment, the applicant's email address is used at the unique ID or username in the applicant database, however, it is also possible that a separate username is requested and/or automatically given to uniquely identify the applicant. In the former case, an applicant usually cannot create more than one account associated with the same email address.

After confirming the email address 305, the applicant can proceed to login to the applicant portal by providing his or her username (email address in a preferred embodiment) and password. Of course, if the confirmation step 305 is removed, the applicant may not be required to login to the portal 307 as the creation of the applicant's account will proceed to automatically log the applicant into the portal. If the applicant has forgotten her password, a retrieval mechanism will be provided as to email the applicant a new password or else allow the applicant to reset her password.

After logging in to the applicant portal 307, in a preferred embodiment, the applicant is presented with the basic information that was already entered on the Registration Page and asked to verify and/or modify the basic information 309. If the basic information has changed or is incorrect, the applicant may change the basic information at that time. In such case, the data is transmitted to the host server 201 in order to update the applicant profile stored in the database. The applicant may proceed to answer more questions to complete the entire employment application.

The additional questions may be on a single page or separated onto different pages or tabs, or effectuated in any manner desired. In a preferred embodiment, different tabs are used such that the applicant may quickly and easily navigate the portal to enter her information. For instance, a tab entitled “Additional Questions” might ask the applicant for information such as: whether she is legally able to be employed in the U.S.; whether she has served in the U.S. Armed Forces, and if so, which branch; what type of discharge received; whether she has a valid drivers license; how she plans on getting to work; whether she has ever been convicted of a felony, and if so, an explanation; what is her highest level of education, and which high school she attended; whether she speaks any foreign languages, and if so, which ones; and finally, anything else important that the applicant would like the potential employer to know.

The above list of data information to be requested from the applicant is merely exemplary and not intended to be limiting. Moreover, one will realize that some of the questions can be best answered with checkboxes (e.g., foreign languages), some can be best answered with text boxes, some with dropdown options, and some with text areas. Other methods of inputting data may be used (e.g., radio buttons, etc.).

In a preferred embodiment, an additional tab or page is provided that allows the applicant to further supplement his application with additional information 311. This tab or page is entitled “Work Preferences” and allows the applicant to enter information particular to the type of employment she is seeking. For instance, exemplary data requested by this tab may be: the minimum hourly wage the applicant is willing to accept; the distance the applicant is willing to commute to work; the type of employment the applicant is willing to consider (e.g., full time, part time, seasonal, etc.); the industries the applicant is willing to work within; how many hours per week the applicant is willing to work; how soon the applicant can begin work; the particular days and times that the applicant is willing to work; and the types of industries the applicant is willing to within (e.g., construction, retail, restaurant, etc.). Again, these fields are not intended to be limiting to the invention described herein, but are merely exemplary.

In a preferred embodiment, an additional tab or page is provided that allows the applicant to further supplement her application with additional information 311. This tab or page is entitled “Employment History” and allows the applicant to enter previous employers and information about previous employment, if applicable. Information requested could be the name of a previous (or even current) employer, the previous position, the length of previous employment, and a brief explanation of duties.

Various design choices can be made as how to transmit this additional applicant profile information to the host server 201. For instance, the information may be “saved” and transmitted to the host server 201 for storage in the database after each tab or page is entered, or it may be transmitted and stored periodically, or it may be transmitted and stored at the end of the Website interaction, to give a few examples.

The applicant portal Website further requests or instructs that the applicant supplement her application 311 with a link to a video of the applicant 313. In a preferred embodiment, a tab is provided that is entitled “Video Application,” and this tab requests that the applicant enter a Web link 313 to a video in order to enhance the application and increase the applicant's chances of finding a job. In this way, the portal does not need to store the video itself since this would increase the overhead storage cost of maintaining the Website, and rather, the Web server 201 can parse or otherwise use a link entered by the applicant to point to a video stored by a different video hosting platform 211. In a preferred embodiment, Youtube is used as the video host 211 and the applicant is requested to provide a Youtube link, which is a short (e.g., 15-25 seconds) video of the applicant explaining why the applicant would make a good employee.

In a preferred embodiment, the host server 201 is able to store a link to the video stored by the video hosting platform 211. However, in an embodiment shown alternatively to that shown in FIG. 2, the video may instead uploaded to the Website (and stored on the hose server 201) instead of a link provided, so long as storage space is not a concern.

This aspect of the applicant portal allows the applicant to showcase personal skills that are usually only made available during an interview. Currently, the only option for employers is to call in an applicant based on a written or electronic application. As that is the only current option, many hourly-wage employers waste much time calling in potential employees only to find that their personal and verbal skills are lacking for the workplace environment. In the present invention, the applicant may record (via any recording device, such as a Webcam, mobile phone, or any other video recording device) a short, professional speech made regarding the applicant's suitability for an employment position. Many teens and other seeking hourly wage employment own smartphones, laptops, PCs, and other electronic devices that are capable of video recording. Thus, the process should be relatively simple for a person to record a video and then upload it to YouTube. After uploading the video to YouTube, the applicant would copy and paste the link into a text box on the applicant portal, which would then store the link to the video in the applicant database. Allowing the applicant the ability to link this video to the hourly wage employment application greatly enhances the job application and greatly enhances the employer's ability to conduct an effective hiring practice.

Once the applicant has entered all or some of the additionally requested information 309, as well as optionally provided a link to a video clip 313, the applicant profile is understood to be more complete. The host server 201 database may optionally store an indication of the percentage complete of an application, based on the amount of data entered by the applicant.

The calculation of the percentage completion of an application may decide to weight some data fields more importantly than others. In addition, some of the data field might have no relevance to the percentage completion whatsoever. For instance, if the applicant did not have any previous employment history, it wouldn't necessarily be accurate to decrease the percentage completion of his application because there was no previous employment listed. Likewise, it is important for an applicant to always indicate their availability. Thus, these two data field would be treated differently for purposes of calculating the percentage completion of the application.

It is to be understood that other features and aspects of the applicant portal may be offered to the applicant. For instance, an “Applicant Tools” tab may be offered at the top that shows the applicant various information. This information might start with the application percentage complete, along with a list of areas of the application left to complete. This list could include hyperlinks such that it would take the applicant to the part of the application to complete if he were to click on the hyperlink. Likewise, an option may be offered to auto-generate a resume in a suitable format (e.g., word doc or pdf) such that the information entered by the applicant may be formatted and output to a resume format. This could be achieved by the applicant simply clicking a button that generates a resume based on the data stored in the applicant profile. Some software code library that interfaces with Office would be an example of how to achieve this (e.g., python Win32COM extensions). This could be quite a useful tool for an hourly-wage applicant, especially considering that many hourly wage employees likely do not have a resume. And finally general informative data (e.g., application tips and interview tips) may be offered on the Applicant Tools tab.

An additional tab named “Account Settings & Preferences” may be offered that allows the applicant to adjust contact setting, such as designating whether the applicant wishes to be contacted via text message in the event of an employer match. Also, email preferences and employment status may be logged on this tab. Finally, the applicant may change their password, delete their account, or else designate whether an employer has permission to run a background check.

Additionally, the Web application may be integrated with Google maps or some other map API such that various employment opportunities within a specified radius of the applicant's home address are shown. In a preferred embodiment, these various employment opportunities are addresses selected from the employer profile database (further discussed below), and are made available on a marketing type page that attempts to get the applicants to sign up. The names of the employer stores/company names may or may not be shown in the map. This map may be optionally offered on the home page before the applicant has registered, and may show a particular city or location with a specific radius, the city or location selected based on the IP address of the end-user visiting the home page. In this way, the map may be used as an encouragement to get the applicant to register an account and apply for a job. In addition, as explained above, this map may be optionally offered after the applicant has created an account and entered profile information. The map may be displayed and the employers filtered based on information entered by the applicant (e.g., location willing to commute, industry preferred, etc.).

In a preferred embodiment, the applicant portal and application collection service is provided to the job applicant free of charge. However, it is also possible to include some application charges, however, this might not be a viable business model as charging persons seeking hour wage employment is a questionable business strategy. If an application charge is implemented, or even a charge for additional features is implemented, persons with ordinary skill in the art would understand how to integrate a payment processing system with the aforementioned techniques.

Likewise, the same description of creating and supplementing an applicant profile that is given above maybe effectuated via a mobile app, or on an iPad, PDA, or even at a kiosk in a shopping mall. In an alternative embodiment, the data may be gleaned from paper applications by scanning, OCR'ing, and automatically retrieving and storing the data from the paper applications. The above-described system may be integrated with a text messaging service such that texts are transmitted to the applicants to remind them to supplement or complete their application. Likewise, various authorizations may be requested from the applicant such as permission to share the video, permission to run a background check, and permission to transmit text messages to the applicant.

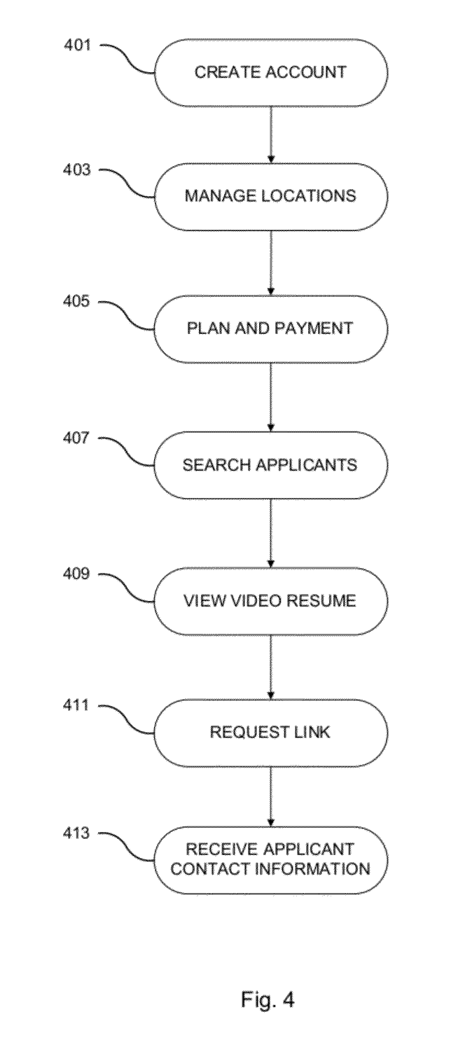

Turning now to FIG. 4, high-level process flow is shown associated with the employer interaction with the Web server 201. Initially, an employer might be browsing a marketing Web page, which might include information about the Website and services offered, demonstration videos, testimonial reports, packages and pricing, and other marketing and informational materials. In any event, the process begins when the employer decides to create an account 401 in order to utilize the hiring services. Typically, in order to create an account, specific information is required to be provided by the employer. In a preferred embodiment, the information requested for account creation is the employer's first name, middle initial, last name, company name, email address, password, phone number, address, city, state, and zip code. At this point, for instance, the employer may be required to agree to the Website's terms of use.

Once the information is entered by the employer, the employer clicks a button to “Register”, thus creating an account of the employer 401 by creating an employer record in the employer database. The employer database and the applicant database may be the same database with different tables, or may be different databases altogether, or may be effectuated via a distributed database or the like. However, the specific implementation is not important to the invention described herein.

In any event, once the employer registers, he may be required to verify the email address (as described for the applicant above), however, in a preferred embodiment the employer is not required to verify the email address but instead is directed to a Webpage titled “Manage Locations” 403. The “Manage Locations” Webpage is a step that 403 allows the employer to enter different stores that he owns (for instance, a Subway store on Main St. and a Boston Market store on Broad St.). In this way, when the system recognizes that a location is not yet associated with an employer, the next step is that a location is required to be entered in order to know for which store the employer wishes to hire. It should be clarified that the company name listed above would typically be different than the location name, but might also be the same. This would be where Company A is dba Company B. Often, Company A is the management company that owns and operates various “locations”, and thus this functionality is provided in the systems and methods described herein. From the Manage Locations page, the employer is also able to edit or delete locations associated with his account, as well as add new locations.

In order to add a location, the employer may be required to enter specific location information such as the location name (e.g., Brice Rd. Subway), industry (e.g., fast food), address, city, state, zip, location phone number, and the number of employees at the location. Dropdowns or text boxes (or any other method) may be used for entering the information required to create a location. A “location name” as described herein may be an address, a store name, a moniker, or any other descriptive information (or combination thereof) associated with a particular store.

By way of example, the industry might be selected from predetermined list, such as: Accounting & Finance, Administration & Office Support, Agriculture & Environment, Automotive, Computers & Technology, Construction, Customer Service, Education, Food & Restaurant, Government & Military, Healthcare, Hotel & Hospitality, Installation & Repair, Law Enforcement & Security, Legal, Maintenance & Janitorial, Management, Media & Entertainment, Personal Care & Services, Retail, Sales & Marketing, Salon/Spa/Fitness, Social Services, Telecommunications, Transportation, Warehouse & Production, and Wellness. This list is purely exemplary, and any appropriate industry list may be used to categorize the types of jobs.

Once this location information is entered, the employer is prompted to activate the location by choosing a payment plan to associate with the location and designating his payment method 405. In a preferred embodiment, a monthly subscription service will be offered for a monthly fee. In a simple embodiment, any employer with less than x number of employees (say, 100) will pay a flat rate fee of $50 per month to use the system for its hiring. Of course, discounts may be offered to entice the employer to register more locations, so that a tiered pricing strategy is employed. Also, a ticketing type “pay per usage” strategy may be employed so that rather than a flat monthly fee, employers are charged based on their usage of the site or the number of employees they have.

In any event, after the location is entered, the employer is prompted to choose a payment method and/or pricing plan 405. This serves to “activate” the location so that the employer may not perform searches and other functions for that location. Once the plan is selected, the method of payment may be entered by the employer. A payment platform may be integrated, and detailed examples of payment information and entry is not required.

Once at least one location is entered and considered active, the employer may search 407 the applicant database for applicants that it wishes to hire. In a preferred embodiment, there is a basic search and an advanced search functionality. The basic search includes a dropdown for the employer to select the store location for which the search will be performed. In a preferred embodiment, the basic search also includes the following “important” fields: work availability, age requirement, distance of applicant's residence to the store location, how soon the applicant can begin, the type of employment desired (full time, part time, etc.), minimum level of education requires, whether a valid drivers license is required, and whether the applicant is required to have any particular industry experience. The employer may select or enter values for these search criteria, and a button showing the # of matches will be shown to the employer.

So, as an example, the default values may be any work availability, any age requirement, applicant to live within 50 miles of the store location, any type of employment, no level of education required, no valid drivers license, and no required industry experience. This might yield 1,500 results, as indicated by a “# of Matches” button showing 1,500 matches. But then as the employer chooses that he wishes the applicant to live “within 10 miles of the store location”, the “# of Matches” button would update showing only 300 matches. The, when he chooses that fast food industry experience is preferable, possibly 120 matches are shown on the button. Finally, the employer chooses that full-time employment is required, and this drops the number of matches to 60. Then, once the employer clicks on the “# of Matches” button, a table of search results is generated that shows the 60 matches in tabular form.

In a preferred embodiment, a table of results is shown that lists the following fields: the first name and last initial of the applicant, the distance from the applicant's home to the work location, the percentage completion of the application, how soon the applicant can begin work, whether the applicant has a video resume 409 (and if so, a link or icon to click on to watch it), whether the applicant allows a background check to be generated (and if so, a link or icon to do so), a link or icon to “link up” with the applicant 411, and a link or icon to “save” the applicant to a dashboard.

The applicant's name may be a link such that clicking on the link will open a new Webpage (“applicant viewing page”) that contains the entire or a subset of the applicant profile for the employer to view. Note that the applicant's contact information is specifically withheld (address, phone, email address) in a preferred embodiment because the system will be used to link the employer with the applicant. But other information is viewable, and other actions are allowed from the applicant viewing page. For instance, the employer may unlock the video resume and may choose to pay a nominal fee to watch the video resume 409. By doing so, the system is integrated with the video platform to allow access to the clip. Additionally, the employer may choose to order a background check, or may prefer to wait to run a background check until later, or not run a background check at all. Likewise, the employer may try to link up with the applicant, save the applicant to the stored applicants dashboard, or else indicate that the employer is not interested in the applicant (to gray out the applicant in the table).

If the “link up” icon or link is selected 411, the employer has designated that he is interested in linking up with this applicant. In a preferred embodiment, a popup allows the employer to enter any specific information to the applicant, and an email and text message is then sent to the applicant informing them that the employer wishes to link. The applicant is instructed, for instance, that “Subway wishes to link up with you, do you agree to allow us to provide your contact information to Subway?” The applicant can respond either yes or no via email or text (or any other means). If the applicant respond yes, then his contact information may be shared with the store location 413. If the applicant responds no, then his contact information may not be shared with the store location. If the applicant does not respond, then after a particular time period (e.g., 1 month) the applicant is determined to be “unresponsive.”

In a preferred embodiment the result table may have some color coordination to represent the status of the applicant. For instance, a green row might indicate that the applicant has accepted the link request and is therefore already “matched” to the employer. A yellow row might indicate that a link request is pending to the applicant. A blue row might indicate that the applicant is stored in the “stored applicants” dashboard (described more fully below). A red row might indicate that the applicant has already declined a link request.

The table might also have a “move up” and “move down” functionality to indicate that the employer is not interested in the applicant. This would gray out the applicant if the employer clicks on a button to move the applicant down, and un-gray the applicant if the employer clicks to move the applicant up. The “save” button allows the applicant to be saved to a “saved applicants” dashboard. This dashboards saves applicants by location in a preferred applications, so that the employer might log back in at a later time to view the applicant by clicking on a “Saved Applicants” tab.

In short, the results table is an output of a search the employer conducted on the applicants. The specific implementation of the results table, including which fields are displayed and what actions are able to be taken, is flexible in the above described invention. The detailed description above is provided simply for explanatory purposes.

That database will also preferably store the employment status of the applicant. So if the applicant is linked and then matched to an employer, an email can be sent to the applicant and the employer a few weeks later to determine whether the applicant has been hired. If the applicant has been hired, then the database will be updated to indicate this fact. In essence, this will be used to make sure that the applicant is no longer returned in search results (unless the applicant changes his status to “looking” again).

In addition to email and/or text message, the invention described herein may also or otherwise include an internal messaging system where Website stores the messages sent and received to the users.

In a preferred embodiment, an advanced search is also provided that includes the ability for the employer to search any or all of the data fields entered by the applicant. A keyword search on the text fields is also possible. In the result table, may of the fields are sortable by clicking a button at the top of the table. Other features may be offered for simplified use of the platform.

An employer “Account Info” tab may also be offered that allows the employer to modify his account and contact information, as well as the billing information associated with his account. In this way, if the credit card number associated with the payments for a location is changed, the employer may reflect this change by modifying the card number in the “Account Info” page.

In a preferred embodiment, the inventive systems and methods provide a feature whereby the employer can add other uses to his or her account. For instance, often a small business owner has a manager that performs the hiring functions. And although the owner will create the primary “admin” account, he will want to link up other uses to his account to perform various tasks.

Therefore, in one exemplary embodiment an employer might click on a tab entitled “Manage Users” and be presented with the option to add a new user (or edit/delete users if they already exists). To add a new user, the employer is required to enter the new user information, including name, email address, and the like. The user is then associated with that “admin” employer account, and the employer may be able to designate certain privileges for the “sub-user”. For instance, the employer can designate whether the new sub-account is able to add new users, delete users, add locations, delete locations, and the like. Additionally, the employer (admin user) may be able to designate certain location-specific privileges for the sub-account. For instance, per location, the employer may designate whether the sub user is able to search & view applications, link up with applicants, or authorize purchases (e.g., video resumes or monthly services).

One will understand that there is a variety of type of implementations for an account authorization functionality to be incorporated into the present invention, and as such, the above examples are exemplary and not intended to limit the invention in any way.

The above system might also include a messaging system for both the applicants and the employers, such that an email-type inbox messaging system is employed by the site. This is useful for tracking messages between the applicants and the employers, as well as messages between the system and the applicants/employers.

Moreover, in addition to the basic search and the advanced search described above, it is also possible for the methods and systems to provide the employer with a suggested search. The goal of the suggested search could be at least to (1) choose the applicants that have the highest chance of being a great employee; (2) choose the applicants that have the highest chance of remaining at the job for a long period of time, thereby reducing the turnover rate of the employer, and (3) limit the number of potential applicants in the results table to a manageable number for the employer to review. In order to find the applicants that have the highest chance of being a great employee, percentage completion of the application may be an important factor. In one embodiment, the system can use the employment status field in the database, along with a timestamp corresponding to the same, to determine what types of applicants are employed for a long time at any particular job. This allows the system to correlate this data with other applicants, and thereby determine the field(s) that are important to suggesting a “great” employee match. A primary goal may be to determine the most important fields when hiring, and there are other various ways for doing so.

As described above, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology.

What is claimed is:

1. A computer-implemented method for providing an employment website, said method comprising:
providing an applicant user interface to a job applicant;
receiving at a host server first data from the job applicant via the applicant user interface, said first data including contact information of the job applicant, the available work hours of the job applicant, the residence address of the job applicant, and a link to a video of the job applicant;
storing an applicant profile for the job applicant on the host server, said applicant profile including at least the first data;
providing an employer user interface to an employer;
receiving at the host server second data from the employer via the employer user interface, said second data including contact information for the employer and additional employer information;
storing an employer profile for the employer on the host server, said employer profile including at least the second data;
receiving at the host server third data from the employer via the employer user interface, said third data including search criteria related to data received from the job applicant;
providing search results to the employer via the employer user interface, said search results based on the search criteria;
providing an option for the employer to sort the search results via the employer user interface; and
providing an option for the employer to view the video of the job applicant via the employer user interface.

2. The method of claim 1, further comprising:
providing an option for the employer to request to be connected with the applicant;
sending a request to the applicant, said request including employer information and requesting the applicant's permission to share the applicant's contact information with the employer;
receiving a response from the applicant, said response indicating whether the applicant authorizes the applicant's contact information to be shared with the employer; and
sending a message to the employer,
wherein the message includes the applicant's contact information if the applicant authorized the contact information to be shared with the employer, and wherein the message does not include the contact information if the applicant did not authorize the contact information to be shared with the employer.

3. The method of claim 1, further comprising:
providing an electronic map to the applicant via the applicant user interface, said electronic map showing an indication for each employer based on the employer address and said electronic map centered on the residence address of the job applicant.

4. The method of claim 1, further comprising:
providing an option for the applicant to automatically generate a resume via the applicant user interface, said resume generated based on the data stored as the applicant profile.

5. The method of claim 1, further comprising:
providing an option for the employer to request a background check of the applicant.

6. A system for providing an employment website, said system comprising:
an applicant user interface module for providing an applicant user interface to a job applicant;
a first data receiving module for receiving at a host server first data from the job applicant via the applicant user interface, said first data including contact information of the job applicant, the available work hours of the job applicant, the residence address of the job applicant, and a link to a video of the job applicant;
an applicant profile module for storing an applicant profile for the job applicant on the host server, said applicant profile including at least the first data;
an employer user interface providing module for providing an employer user interface to an employer;
a second data receiving module for receiving at the host server second data from the employer via the employer user interface, said second data including contact information for the employer and additional employer information;
an employer profile module for storing an employer profile for the employer on the host server, said employer profile including at least the second data;
a third data receiving module for receiving at the host server third data from the employer via the employer user interface, said third data including search criteria related to data received from the job applicant;
a search results module for providing search results to the employer via the employer user interface, said search results based on the search criteria;
a sorting option module for providing an option for the employer to sort the search results via the employer user interface; and
a video module for providing an option for the employer to view the video of the job applicant via the employer user interface.

7. The system of claim 6, further comprising:
a connection module for providing an option for the employer to request to be connected with the applicant;
a request module for sending a request to the applicant, said request including employer information and requesting the applicant's permission to share the applicant's contact information with the employer;
a response module for receiving a response from the applicant, said response indicating whether the applicant authorizes the applicant contact information to be shared with the employer; and
a message sending module for sending a message to the employer,
wherein the message includes the applicant's contact information if the applicant authorized the contact information to be shared with the employer, and wherein the message does not include the contact information if the applicant did not authorize the contact information to be shared with the employer.

8. The system of claim 6, further comprising:
an electronic map module for providing an electronic map to the applicant via the applicant user interface, said electronic map showing an indication for each employer based on the employer address and said electronic map centered on the residence address of the job applicant.

9. The system of claim 6, further comprising:
a resume generation module for providing an option for the applicant to automatically generate a resume via the applicant user interface, said resume generated based on the data stored as the applicant profile.

10. The system of claim 6, further comprising:
a background check module for providing an option for the employer to request a background check of the applicant.

11. A computer-implemented method for matching an applicant to an employer based on the applicant's application, said method comprising:
providing an employer user interface to an employer;
receiving at a host server first data from the employer, said first data including location and contact information regarding one or more employment locations;
receiving at the host server second data from the employer, said second data including a designation of one location from the one or more employment locations, and said second data also including employer requirements, said employer requirements including work availability required by the employer and at least one piece of information selected from the group consisting of: the minimum age required by the employer, the maximum distance from the designated location's address to an applicant's home address required by the employer, how soon the applicant must be able to begin work, the type of employment required by the employer, the minimum level of education required by the employer, whether a valid drivers license is required by the employer, and the previous industry experience required by the employer;
providing the employer with a table of one or more applicants, said table of one or more applicants conforming to the requirements included in the second data, and each row in said table of one or more applicants including at least three pieces of information for each of the one or more applicants, said at least three pieces of information selected from the group consisting of: distance from applicant home address to the location address, percentage completeness of applicant application, how soon the applicant is able to begin work, whether the applicant had provided a video, and whether the applicant had authorized a background check;
receiving at the host server a request from the employer to view an applicant video, said applicant video previously provided by the applicant;
providing the employer with an interface for viewing the applicant video;
receiving at the host server a request from the employer to connect with the applicant;
sending a message to the applicant from the host server, said message including employer information or location information, and said message further requesting the applicant's permission to share the applicant's contact information with the employer;
receiving at the host server a response from the applicant, said response indicating whether the applicant authorizes the applicant's contact information to be shared with the employer; and
providing the applicant's contact information to the employer if the applicant authorized the applicant's contact information to be shared with the employer.

12. The method of claim 11, further comprising:
providing the employer with the number of applicants that conform to the requirements in the second data before providing the employer with the table of one or more applicants; and
receiving at the host server a request from the employer to be provided with the table of one or more applicants.

13. The method of claim 11, wherein the table of one or more applicants further includes:
an icon or link in each row that enables the employer to request to connect with each of the one or more applicants; and
an icon or link in each row that enables the employer to save the applicant to a saved applicants list.

14. The method of claim 13, wherein the table of one or more applicants is color coded by applicant based on at least whether the one or more applicants are saved to the saved applicants list, whether the one or more applicants have an outstanding connection request, and whether the one or more applicants have already responded to a connection request.

15. The method of claim 11, wherein the response from the applicant is via email or via text message or via an internal system message.

16. A system for matching an applicant to an employer based on the applicant's application, said system comprising:
an employer user interface module for providing an employer user interface to an employer;
a first data receiving module for receiving at a host server first data from the employer, said first data including location and contact information regarding one or more employment locations;
a second data receiving module for receiving at the host server second data from the employer, said second data including a designation of one location from the one or more employment locations, and said second data also including employer requirements, said employer requirements including work availability required by the employer and at least one piece of information selected from the group consisting of: the minimum age required by the employer, the maximum distance from the designated location's address to an applicant's home address required by the employer, how soon the applicant must be able to begin work, the type of employment required by the employer, the minimum level of education required by the employer, whether a valid drivers license is required by the employer, and the previous industry experience required by the employer;
a table providing module for providing the employer with a table of one or more applicants, said table of one or more applicants conforming to the requirements included in the second data, and each row in said table of one or more applicants including at least three pieces of information for each of the one or more applicants, said at least three pieces of information selected from the group consisting of: distance from applicant home address to the location address, percentage completeness of applicant application, how soon the applicant is able to begin work, whether the applicant had provided a video, and whether the applicant had authorized a background check;
a video request receiving module for receiving at the host server a request from the employer to view an applicant video, said applicant video previously provided by the applicant;
a video module for providing the employer with an interface for viewing the applicant video;
a connection request module for receiving at the host server a request from the employer to connect with the applicant;
a message sending module for sending a message to the applicant from the host server, said message including employer information or location information, and said message further requesting the applicant's permission to share the applicant's contact information with the employer;
a response receiving module for receiving at the host server a response from the applicant, said response indicating whether the applicant authorizes the applicant's contact information to be shared with the employer; and
a contact providing module for providing the applicant's contact information to the employer if the applicant authorized the applicant's contact information to be shared with the employer.

17. The system of claim 16, further comprising:
a number providing module for providing the employer with the number of applicants that conform to the requirements in the second data before providing the employer with the table of one or more applicants; and
a table request receiving module for receiving at the host server a request from the employer to be provided with the table of one or more applicants.

18. The system of claim 16, wherein the table of one or more applicants further includes:
an icon or link in each row that enables the employer to request to connect with each of the one or more applicants; and
an icon or link in each row that enables the employer to save the applicant to a saved applicants list.

19. The system of claim 18, wherein the table of one or more applicants is color coded by applicant based on at least whether the one or more applicants are saved to the saved applicants list, whether the one or more applicants have an outstanding connection request, and whether the one or more applicants have already responded to a connection request.

20. The system of claim 16, wherein the response from the applicant is via email or via text message or via an internal system message.
